(19) United States
(12) Patent Application Publication
(10) Pub. No.: US 2005/0168446 A1
(43) Pub. Date: Aug. 4, 2005

(54) Integrated keypad keyboard plus mouse and two click mechanism for an electronic device

(76) Inventor: Muntaser Q. Majdoub, Redwood city, CA (US)

Correspondence Address: GRAFFITI PROMOTIONS, LLC, 827 WINDSOR ROAD, ARNOLD, MD, 21012, US

(21) Appl. No.: 10/771,956

(22) Filed: Feb. 4, 2004

(51) Int. Cl. G09G 5/00

(52) U.S. Cl. 345/168

(57) ABSTRACT

In an embodiment a mobile electronic device is provided with a retractable sliding keypad that in an open position extends from opposite sides of a mobile electronic device and in a closed position both keypads are stored within the main frame of the electronic device. In another embodiment a mobile electronic device is provided with a retractable sliding keypad in addition to a stationary keypad built into the device's main frame and used in combination with the retractable sliding keypads to create one complete linear keyboard. In yet another embodiment a rotating or hinged keypad in addition to a stationary keypad built into the device's main frame and used in combination with the rotating or hinged keypads to create one complete linear keyboard. Additionally the use of mouse buttons and sticks removes the dependence of the keypads on the use of a touch screen or stylus to enter information.

### CROSS REFERENCE TO RELATED APPLICATIONS: Not Applicable

### FEDERALLY SPONSORED RESEARCH: Not Applicable

### SEQUENCE LISTING OR PROGRAM: Not Applicable

### TECHNICAL FIELD OF THE INVENTION

The present invention relates generally to a portable electronic device and more particularly to an integrated keyboard and mouse input device attached to a mobile electronic device.

### BACKGROUND OF THE INVENTION

In the past decade portable electronic mobile equipment, such as computing and communication devices, have been increasingly popular and become virtually indispensable for business and personal purposes. Examples of such electronic mobile devices are cellular phones, mobile communication devices, PDAs (personal digital assistants), pocket calculators and portable personal computers, and combination devices that may include two or more of the previously mentioned electronic mobile devices.

PDAs have especially been gaining in popularity, but since the beginning PDA's have lacked a built in keypad or keyboard because it considerably added to the size and weight of the device and negated its most desired characteristic, portability. Some have tried integrating sliding keypads and keyboards, but have failed to maintain the same device size and remove the dependency of using a stylus or touch screen to enter information that a fully functioning keyboard would eliminate.

In order to make such electronic mobile devices more convenient to transport they are very small in size, which results in miniature displays and input devices that make text entry difficult. Typically a touchpad, keypad, stylus, or pen is used to enter data in limited amounts or while away from a separate full size keypad that may be attached to the mobile electronic device. There are two main methods of data entry into a mobile electronic device. The first is through a small keypad which forces the user into an awkward input operation restricting the options and speed at which data can be entered into such a device. The second common method of data entry is the use of a stylus or pen touch based input. A touch based system utilizes a pen or stylus to input information by contacting a touch screen on the mobile electronic device the consists of a LCD (liquid crystal display) and either (a) writing letters, words, and number, which are then recognized as data by the electronic device or (b) selecting letters, words, and numbers from a keypad image for input which contains a limited amount of characters for data entry.

The previously discussed touched based and pen system severely limits the amount of information a user enters and can also be frustrating to a user with a preference to a keypad system over a touch based input device. Additionally, many users wishing to enter large amounts of data or those composing a text document or email often elect to do so through the use of a larger keypad, but a separate and larger keypad increases the size and weight of the mobile electronic device resulting in diminished portability of the device, it most important feature.

It is this tradeoff between portability, the desirability for a keypad system, and ease of use that is the central issue with the current prior art. Users would like the smallest and lightest device possible that still allows them for easy input of data, text, and voice that is comparable to using a full size computer or similar device, and would prefer a keypad for data entry.

It is now necessary that a new and useful alternative to the current input devices, which make data entry difficult, be developed. Other have offered solutions such as multi-part keypads, folding keypads, and hinged keypad to solve this problem but all have their own limitations ranging from increased size and weight to user balance and stability problems when utilizing these solution to input data into a mobile electronic device. In this way many improvements have been proposed, developed, and tested for the purposes of expanding the variety of input design options, but not have yet been satisfactory from the viewpoint of providing a sufficient input device for a mobile electronic device that strikes the appropriate balance between usability and portability.

### SUMMARY

The present invention addresses the shortcoming in the prior art with respect to providing more efficient and user-friendly input means to a mobile electronic device with sufficient input functions that does not negatively affect the portability of a mobile electronic device by unnecessarily increasing the size, weight, balance, and user comfort of the device.

To achieve the above objectives, according to the present invention, a mobile electronic device adopts the construction as described below. The input means comprises a sliding keyboard member split at the center and contained within the main unit of a mobile electronic device. The sliding keyboard is split into left and right portions so that when these left and right portions are slid respectively leftward and rightward from their stored position within main unit of the mobile electronic device, the sliding keyboard is exposed.

This design enables a standard keypad and other buttons to be arranged in a spit keypad designed typically illustrated in ergonomic style keyboards that feature a split layout of the standard keypad. Additionally mouse buttons and mouse sticks can be placed on the individual keyboard members as desired.

In another arrangement, the input means comprises a sliding keyboard member split at the center and contained within the main unit of a mobile electronic device and a second input device (also referred to as the stationary keyboard) arranged on the surface of the mobile electronic device so as not to be movable relative thereto and in alignment with the sliding keyboard contained therein. The second input device can be used either alone or in conjunction with the sliding keyboard sections of the first input device. The sliding keyboard is split into left and right portions so that when these left and right portions are slid respectively leftward and rightward from their stored position within main unit of the mobile electronic device, the sliding keyboard is exposed. The sliding keyboard and the stationary keyboard together form a laterally elongated keyboard that makes typing easier and enhances flexibility in the layout of the keys and buttons on the keyboard.

In this arrangement a conventional keyboard can be increased in size and enlarged for easier user use and input by utilizing the surface are of the sliding and stationary keyboards while not sufficiently affecting the portability of the mobile electronic device since the sliding keypads can be retracted into the main unit of the device when not in use. In another arrangement the sliding keypad could have the layout as discussed in the first embodiment while the stationary keypad retain input means for the most frequently used input functions or a specific set of functions to control a certain function of the device.

For example, the stationary keypad could contain a number pad (frequently used function) so that the electronic device can function as a phone while the sliding keyboard remains retracted in the main case of the device while the sliding keypads contain standard keyboard characters for use in typing emails or entering other information (infrequently used functions). It is also to be realized that the layout could be combined in that the stationary keyboard not only contains the number pad, but also is used in combination with the sliding keypads to create a larger typing keyboard for entering letters and words.

### BRIEF DESCRIPTION OF THE DRAWINGS

FIG. 1A illustrates a front perspective view of a mobile electronic device with a retractably sliding keyboard device of the current invention;

FIG. 1B illustrates a side perspective view of a mobile electronic device with a retractably sliding keyboard device of the current invention;

FIG. 2 illustrates the mobile electronic device with the retractably sliding keyboard exposed;

FIG. 3A illustrates a front perspective view of a mobile electronic device with the retractably sliding left keypad device of the current invention in the open position;

FIG. 3B illustrates a view of the left keypad device of the current invention and the location of mouse buttons;

FIG. 4A illustrates a front perspective view of a mobile electronic device with the retractably sliding right keypad device of the current invention in the open position and the location of mouse sticks;

FIG. 4B illustrates a view of the right keypad device of the current invention and the location of mouse sticks;

FIG. 5 illustrates the mobile electronic device with the retractably sliding keypads exposed and the preferred locations for mouse buttons and sticks;

FIG. 6A illustrates a front perspective view of a mobile electronic device with a retractably sliding keyboard device of the current invention in another embodiment;

FIG. 6B illustrates a side perspective view of a mobile electronic device with a retractably sliding keyboard device of the current invention in another embodiment;

FIG. 7A illustrates a front perspective view of a mobile electronic device that could be a cellular phone with a retractably sliding keyboard device of the current invention in the open position;

FIG. 7B illustrates a front perspective view of a mobile electronic device that could be a cellular phone with a retractably sliding keyboard device of the current invention in the closed position;

FIG. 8 illustrates the mobile electronic device with the flipping keypads in the open position;

FIG. 9 illustrates the mobile electronic device with the flipping keypads in the closed position.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures, and techniques known to one of ordinary skill in the art have not been shown in detail in order not to obscure the invention.

Hereinafter, mobile electronic devices embodying the present invention will be described with reference to drawings. It is to be understood that, although all embodiments described below deal with compact personal digital assistants (PDAs) and cellular phones as mobile electronic devices, the present invention is applicable not only to this type of mobile electronic device but also to other electronic devices of any other type, for example, personal computers, terminals, and other mobile communication devices as limited examples.

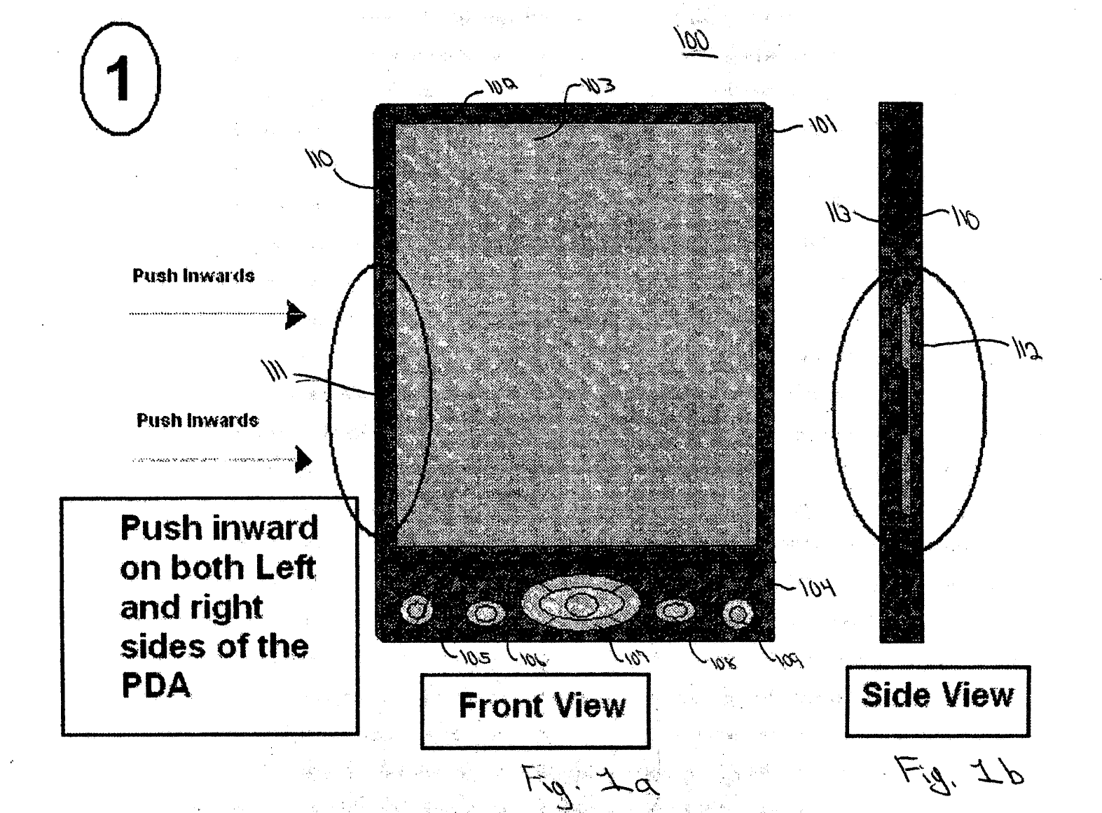

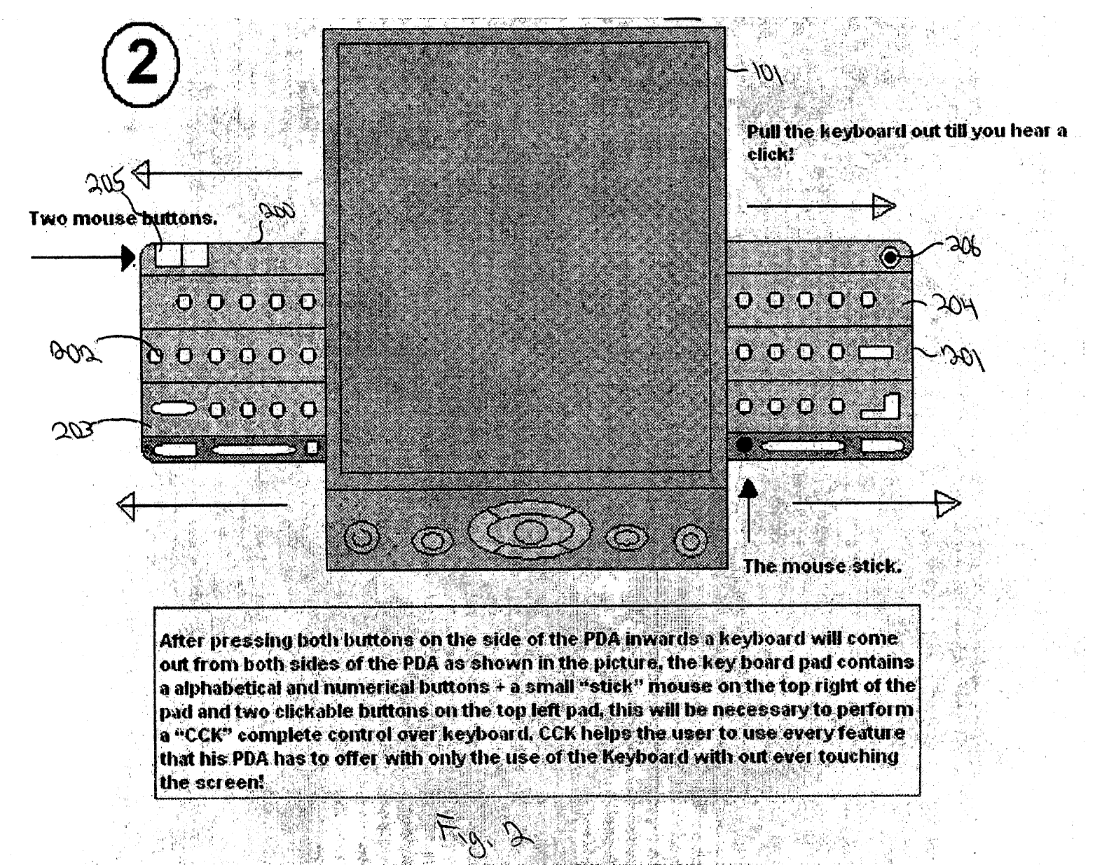

FIG. 1 illustrates a front perspective view of a mobile electronic device (100) that may be a PDA, portable cellular phone, pocket computer, laptop computer, or any other appropriate and/or equivalent type of computing or communication device. The mobile electronic device (100) is comprised of a main case (101) with a top portion (102) that includes a display screen (103). The display screen (103) may be a touch screen, touchpad, LCD, flat-panel display, or any other equivalent screen capable of displaying information. In one embodiment the display screen (103) may accept input from a stylus or pen, but in another embodiment the display screen (103) may not.

The main case (101) is also comprised of a bottom portion (104) that includes multiple input devices (105-109) illustrated here as multi-part buttons and a side portion (110) that has a slot (111) capable of receiving and/or storing a keyboard.

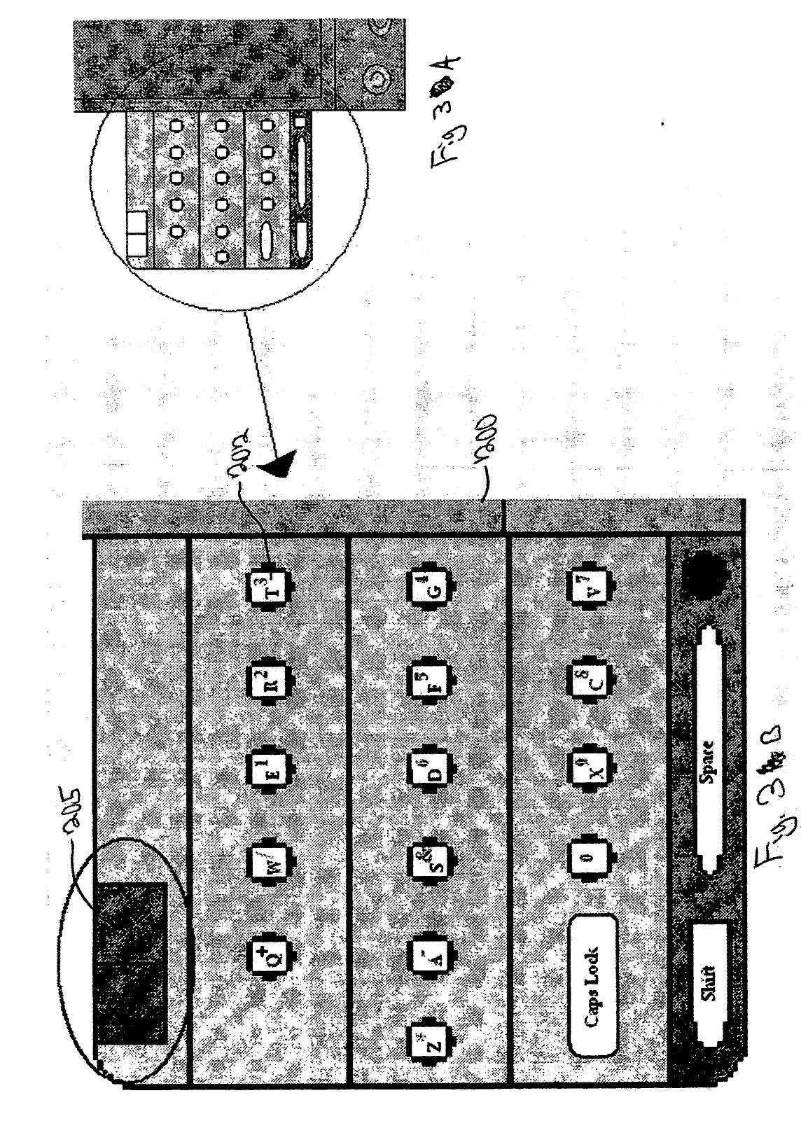

Now referring to FIG. 1b the side perspective of view of a mobile electronic device is shown, a keyboard (112) may move, telescope, slide, or retract between a closed position (shown) inside the slot (111) of the main case (101) and an open position (shown in FIG. 2).

FIG. 2 illustrates the mobile electronic device (100) with the retractably sliding keyboard sections, left keypad (200) and right keypad (201) exposed in the open position. The keypads (200 & 201) remain attached to the main case (101) when in the open position. In one embodiment the keys (202) may we arranged in a QWERTY layout typical of standard typewriters, but in other embodiments any arrangement of the keys (202) may be used and there may be more or less key than a standard typewriter. In other embodiments other components may be connected to the keypad to increase its mass and enhance stability when typing.

After pressing both keypads inward or pressing buttons (113) located on the side (110) of the electronic device (100) inward the keypads will come out from both sides of the device as shown in FIG. 2 and should be pulled until they click into position and are secured by retaining components inside the main case (101). The keypad may slide or retract between a closed position inside the main case (101) and an open position at least partially outside the main case (101). FIGS. 1A and 1B depict the keypads (200 & 201) in their closed position while FIG. 2 shows the keypads (200 & 201) in the open position, which may expose the keys (202), buttons (205), or sticks (206) on the topside (203 & 204) of the keypads (200 & 201) when in the open position.

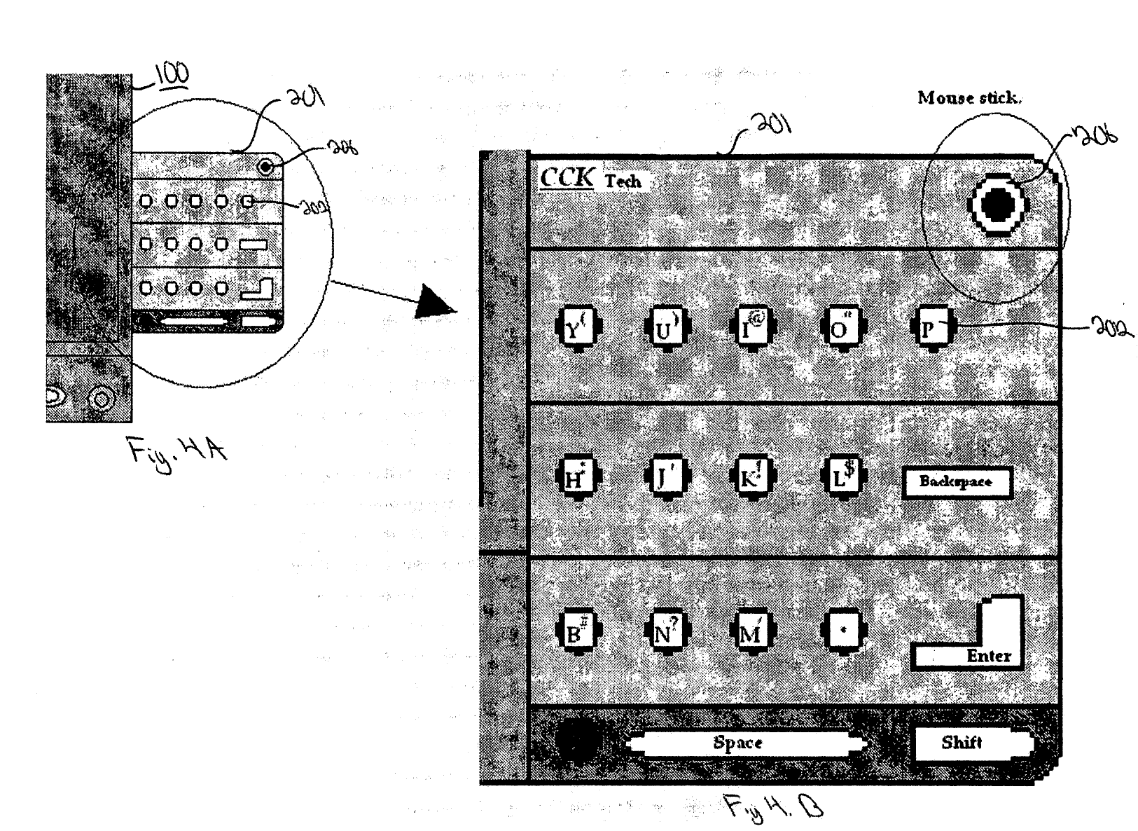

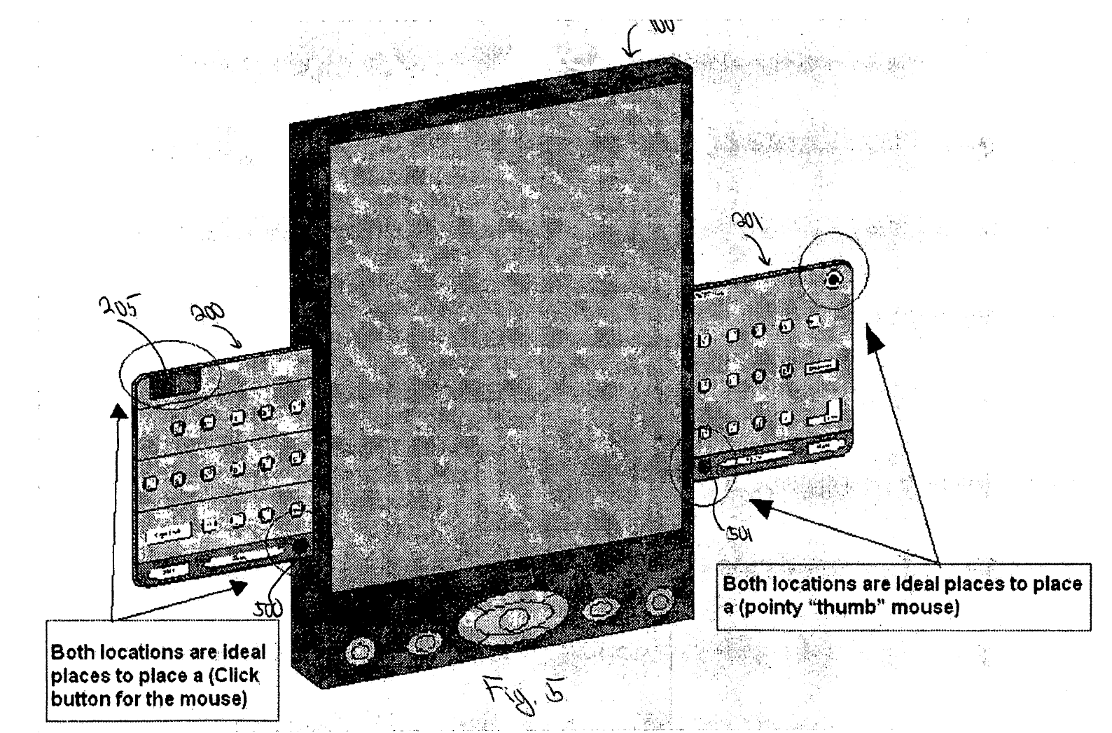

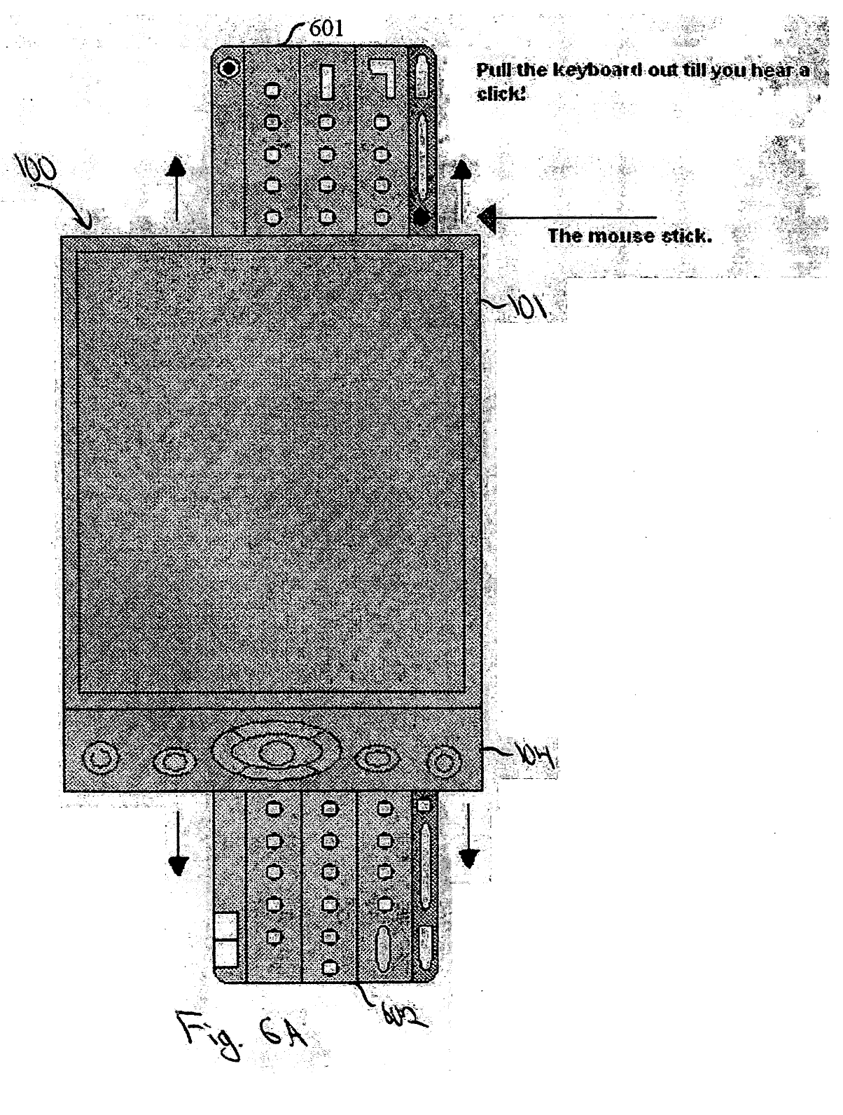

The keypads contain alphabetical and numerical buttons (120), a small “stick” mouse (206) on the top right of the right keypad (201) and two clickable buttons (205) on the top left of the left keypad (200). In one embodiment as illustrated in FIGS. 3A and 3B two clickable buttons (205) on the top left of the left keypad (200) are necessary to perform a “CCK” or complete control over the keyboard. CCK helps the user to use every feature that his electronic device has to offer with only the use of the keyboard without ever touching the screen. FIGS. 4A and 4B illustrate the location of the small “stick” mouse (206) on the top right of the right keypad (201) in this embodiment.

CCK technology (also known as “complete control over the keyboard”) allows a user to never have to touch the screen when they are using the keyboard which is extremely helpful an convenient because it will eliminate the need for the user to constantly reach for the stylus to input commands and data that could not be achieved with the prior art of today's keyboards. Thus, causing the user to constantly keep going back and forth between the keyboard and the stylus to achieve even the simplest commands.

The CCK tech could not be achieved in the past due limitation of the PDA's keyboards and keypads. The present invention overcomes this prior art limitations by including a thumb or stick mouse on the right top and/or bottom left of the right side keypad and placing two mouse click buttons on the right top and/or the bottom left side of the left keypad which allows the CCK technology to be achieve. The mouse buttons and sticks replace the functions of the stylus of touch screen that are required to input information and date into current mobile electronic devices and makes the present inventions keyboard system self sufficient and eliminates and need or use for the stylus our touch screen in connection with the keypad.

One example of how CCK technology works is illustrated when one attempts to use a current day PDA to visit a website or Internet address via any browser program such as Internet Explorer, Netscape, or Modzilla. Today's PDA require the user to first use a styles or equivalent device to “tap” or select the browser program through a screen display interface such as a stylus and then return the external input device to its storage position, then a keyboard device is used to input the internet domain address (also known as a URL). This multiple device input feature used in today's PDAs makes for a very unpleasant user experience. CCK technology enables all required input to be completed using a keyboard and stick mouse, similar to current laptop computers. With CCK, a PDA user wishing to visit a website would simply use the keyboard's stick mouse feature to move an on screen mouse to the browser icon to start the program. The mouse stick is then used in the same fashion to place the cursor in the address bar of the browser so the user can enter the internet address using the keyboard.

The integrated keyboard and mouse stick design of the present invention eliminates the need for a user to require the use of a secondary input device in addition to a keypad. The present invention adapts known computer stick pointers to a keypad used on PDA and similar electronic devices the eliminates the need for a stylus and allows for complete control of the device using only the keypad.

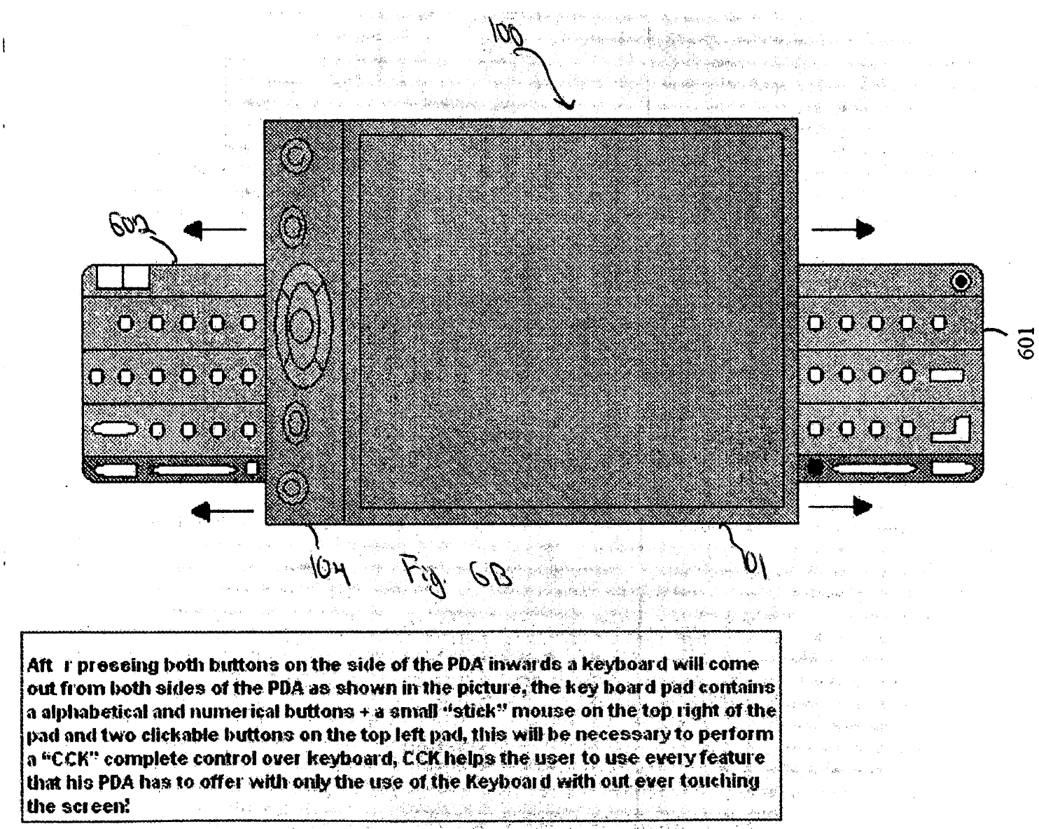

Now referring to FIG. 5 the mobile electronic device (100) is shown with both keypads (200 & 201) in the open position and exposed consistent with a user utilizing them to enter information. The preferred positions of the ideal places to locate a click button for a mouse are shown as being two buttons (205) in the upper left hand corner of the left keypad (200) and also one button (500) in the lower right hand corner of the left keypad (200). The preferred positions of the ideal places to locate a pointy “thumb” mouse or “stick” are previously disclosed is one stick (206) located at the upper right hand corner of the right keypad (201) and one stick (501) located on the bottom lower left portion of the right hand keypad (201).

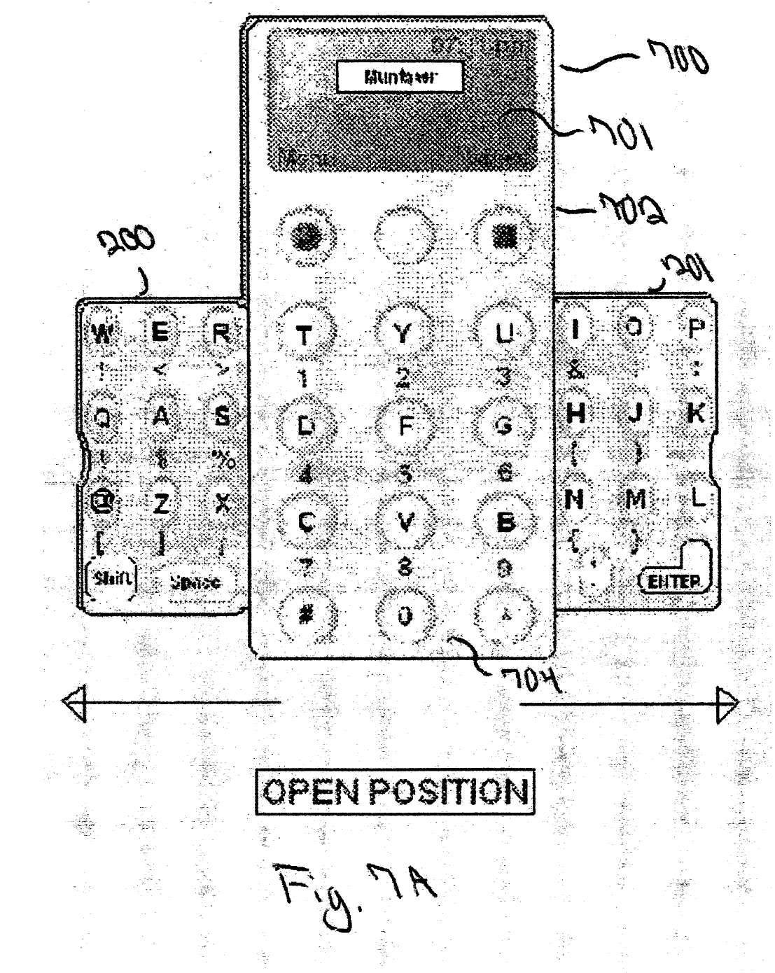

FIGS. 6A and 6B illustrates yet another embodiment where retractable sliding keypads are oriented differently with respect to the main case (100) of an electronic device. In this embodiment the retractable sliding keypads are oriented in such a manner that one retractable sliding keypad (601) extends from the top portion of the main case (101) while a second retractable sliding keypad (602) extends from the bottom portion (104) of the main case (101). The retractable sliding keypads operate in the same manner as previously discussed, but this orientation can allow a user to rotate the screen and still work on the keyboard in a standard orientation.

One advantage of this embodiment is for those who commonly use mobile electronic devices for spreadsheet work. By rotating the device a wider screen image can be used which would reveal more columns on a spreadsheet to the user. In the absence of the keypad orientation of this embodiment a user would have to enter information in a very awkward manner or continually rotate the electronic device in the hand between viewing and entering information functions.

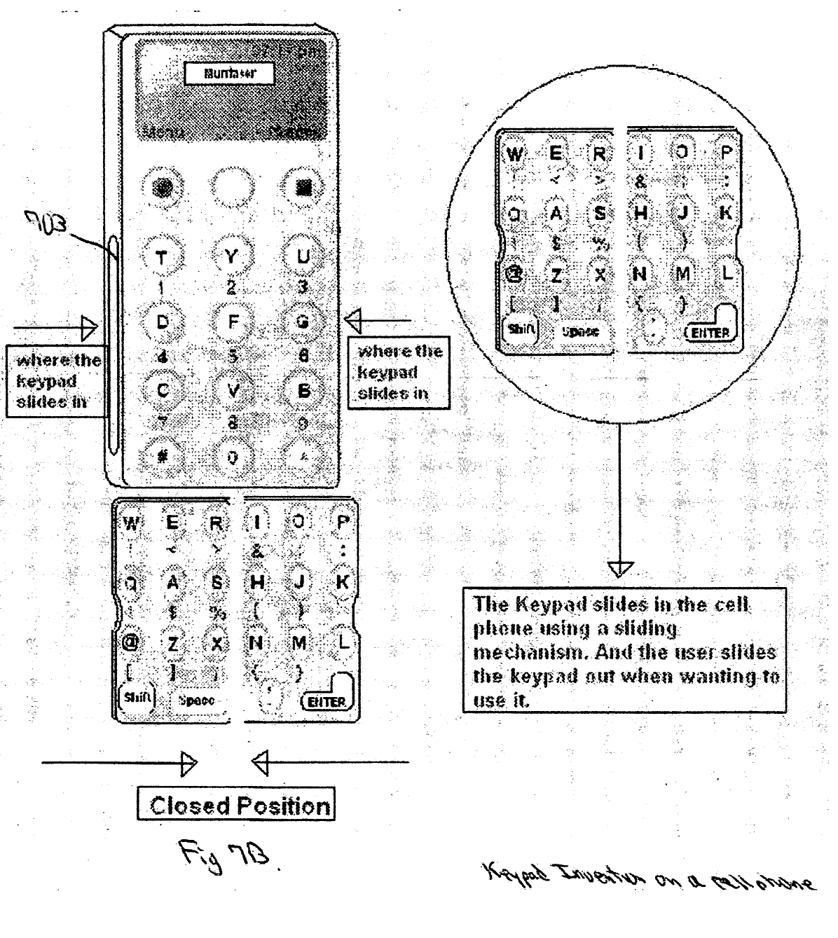

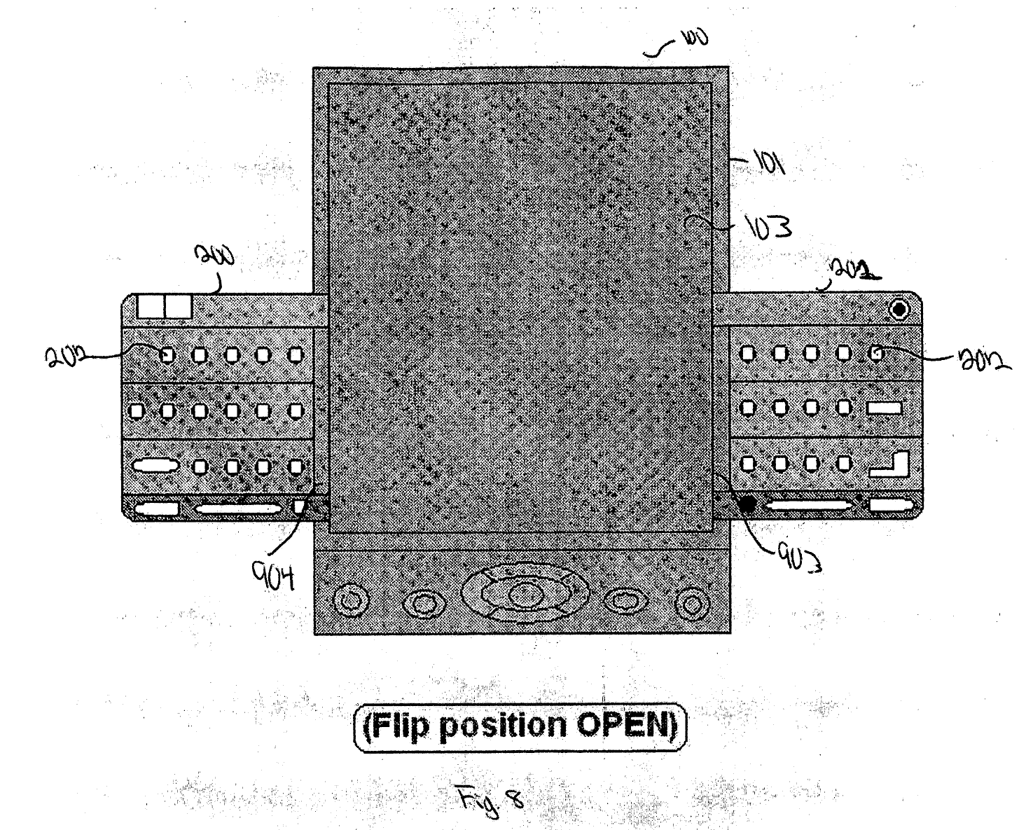

Now referring to FIG. 7A the present invention is embodied using a mobile electronic device that could be a mobile phone (700) which is comprised of a main case (702) that contains a screen (701) and its possible embodiments and equivalents as previously discussed, slots (703) on each side where left and right keypads (200 & 201) may move, telescope, slide, or retract between an open position (shown) inside the slot (703) of the main case (101) and closed position (shown in FIG. 7B). In this embodiment the main case (101) also includes a stationary keypad (704), which is used in combination with the left and right keypads (200 & 201) to form one complete linear and continuous keypad.

It should also be appreciated that the stationary keypad (704) on the main case (101) may or may not be used in connection with the left and right keypads (200 & 201) to form one complete linear and continuous keypad, but that the stationary keypad (704) could contain its own separate controls for various functions of the electronic device not controlled by the left and right keypads (200 & 201).

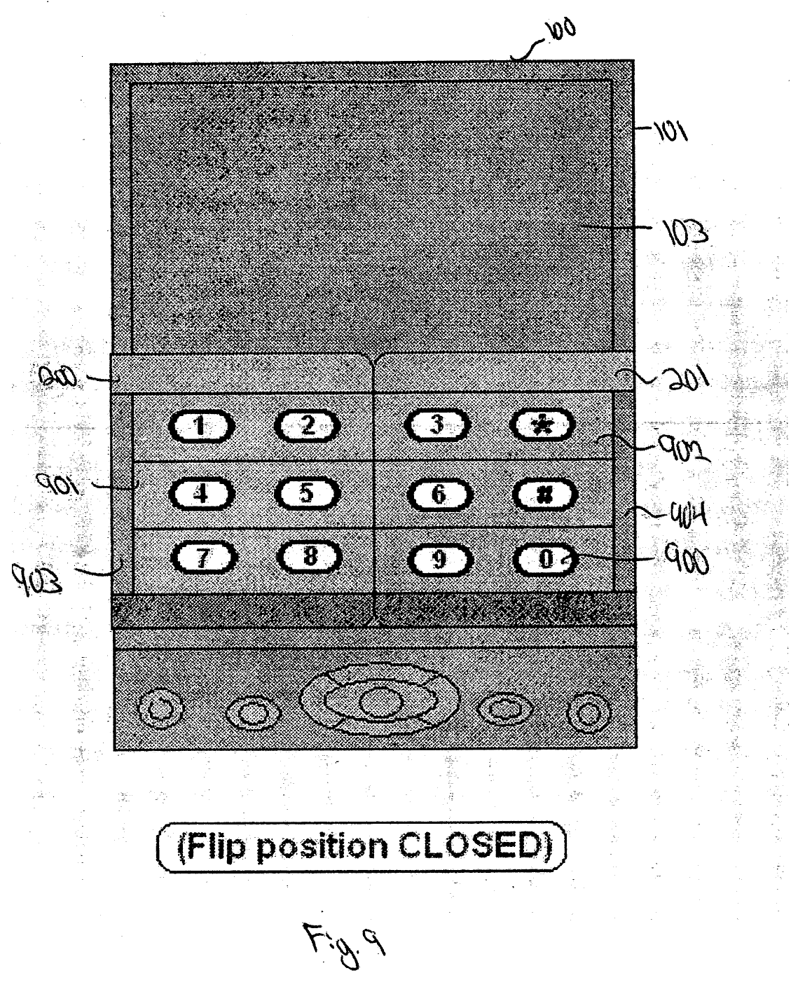

In yet another embodiment the left and right keypads (200 & 201) may be attached to the electronic device's main case (101) via hinges (903 & 904) or any other means of rotatably attaching such as pins the allow it to rotate from an open to closed position. The keypads (200 & 201) individually pivot or rotate between the closed and open positions show in FIGS. 8 and 9 and at least partially cover the screen (103) and main case (101) when in the closed position and remains attached to the main case (101) when in the open position.

Nor referring to FIGS. 8 and 9, when the folding keyboard pads (200 & 201) is in the closed position so that the keys (202) are facing the main frame (101) or screen (103) and hidden from view, there are keys (900) located on the backside (901 & 902) of the folding keyboard pads (200 & 201) for inputting data while the electronic device is in a mode where the full keypad is not necessary or to use secondary or less complex features of the device.

In addition, other areas of art may benefit from this method and adjustments to the design are anticipated. Thus, the scope of the invention should be determined by the appended claims and their legal equivalents, rather than by the examples given.

1. An electronic device comprising:
(a) a main unit to provide data processing function and a display screen;
(b) two input means arranged around the main unit on opposing sides;
(c) input means are coupled to the main unit so as to be movable relative thereto between an open position in which input means protrude from the main unit allowing for input operation and a closed position where the input means is stored and protected, wherein input means slide between the open and closed positions and are retracted into slots on each the side of the main unit.

3. An electronic device as claimed in claim 2 further comprising:
wherein the input means contains standard buttons and numbers in addition to mouse buttons and mouse sticks to provide complete keyboard control of the electronic device.

4. An electronic device as claimed in claim 3 further comprising:
wherein the input means is comprised of two panels, each respectively extended from the main unit of the electronic device, each panel containing standard letter and numbers; the two panels can be combined to form a standard keyboard and are basically two halves of a standard keyboard divide into two sections and place in a opposite orientation around the main unit.

5. An electronic device as claimed in claim 4 further comprising:
wherein the two panels also contain one or more mouse buttons and mouse sticks.

6. An electronic device as claimed in claim 5 further comprising:
wherein the two panels are arranged in a orientation such that one panel is on the left of the display screen and one panel is on the right of the display screen.

7. An electronic device as claimed in claim 6 further comprising:
wherein the two panels are arranged in a orientation such that one panel is on top of the display screen and one panel is on the bottom of the display screen.

8. An electronic device comprising:
(a) a main unit to provide data processing function, and a display screen where said main until additionally comprises a keypad input system;
(b) two input means arranged around the main unit on opposing sides;
(c) input means are coupled to the main unit so as to be movable relative thereto between an open position in which input means protrude from the main unit allowing for input operation and a closed position wherein the input means are stored and protected within the main unit, wherein input means slide between the open and closed positions and are retracted into slots on each the side of the main unit.

9. An electronic device as claimed in claim 8 further comprising:
wherein the input means contains standard buttons and numbers in addition to mouse buttons and mouse sticks to provide complete keyboard control of the electronic device.

10. An electronic device as claimed in claim 9 further comprising:
wherein the input means is comprised of two panels, each respectively extended from the main unit of the electronic device, each panel containing standard letter and numbers.

11. An electronic device as claimed in claim 10 further comprising:
wherein the two panels can be combined to form a standard keyboard and are basically two halves of a standard keyboard divide into two sections and place in a opposite orientation around the main unit.

12. An electronic device as claimed in claims 11 further comprising:
wherein the two panels in conjunction with the keypad of the main until can be combined to form a standard keyboard and are basically each one third of a standard keyboard divide into three sections and place in an orientation around the main unit so as to be aligned to form a standard board.

13. An electronic device as claimed in claim 12 further comprising:
wherein the main unit keypad contains a numerical phone pad and is fully functional when the two panels are in the closed position.

14. An electronic device as claimed in claim 13 further comprising:
wherein the two panels also contain one or more mouse buttons and mouse sticks.

15. An electronic device as claimed in claim 14 further comprising:
wherein the two panels are arranged in a orientation such that one panel is on the left of the display screen and one panel is on the right of the display screen.

16. An electronic device comprising:
(a) a main unit to provide data processing function and a display screen;
(b) two input means arranged around the main unit on opposing sides, wherein the input means is comprised of two panels, each respectively extended from the main unit of the electronic device having a top side and bottom side;
(c) input means are coupled to the main unit so as to be movable relative thereto between an open position in which input means protrudes from the main unit allowing for input operation and a closed position where the top side of the input means is stored and protected, wherein input means rotates between the open and closed positions and when in the closed position, covers a portion of the main unit.

17. An electronic device as claimed in claim 16 further comprising:
wherein the top side input means contains standard buttons and numbers in addition to mouse buttons and mouse sticks to provide complete keyboard control of the electronic device.

18. An electronic device as claimed in claim 16 or 17 further comprising:
wherein the bottom side comprises input means which contains standard buttons and numbers that can be utilized for input means are in a closed position.

19. An electronic device as claimed in claim 19 further comprising:
wherein the bottom side input means exposed while the in the closed position is comprised of a numerical keypad.

20. An electronic device as claimed in claims 1-19 wherein the input means which slide between the open and closed positions and are retracted into slots on each the side of the main unit may also rotate between the open position and a second closed positions and when in the second closed position, covers a portion of the main unit.
